(19) United States
(12) Patent Application Publication
(10) Pub. No.: US 2003/0014913 A1
(43) Pub. Date: Jan. 23, 2003

(54) Decorative attachment to a flower box

(76) Inventor: Ralph H. White, Bridgeport, NY (US)

Correspondence Address: HANCOCK & ESTABROOK, LLP, 1500 MONY Tower I, PO Box 4976, Syracuse, NY, 13221-4976, US

(21) Appl. No.: 09/910,403

(22) Filed: Jul. 23, 2001

(51) Int. Cl. A01G 9/02

(52) U.S. Cl. 47/72

(57) ABSTRACT

The present invention contemplates a decorative attachment to a flower box, comprising modular panels adapted for interconnection to one another. Each panel includes interconnect members having opposing ends, one of which includes a male member extending therefrom and the other of which includes a corresponding female socket. The male members and sockets permit the units to be modular and adaptable to fit various sized flower boxes. Some of the panels further includes a hook attached to their rear surfaces which interconnect the panels to a flower box, and a spacer member that may also be attached to a panel's rear surface. The spacer maintains the panels in a vertically extending plane when connected to a flower box.

### BACKGROUND OF THE INVENTION

The present invention relates generally to ornamental attachments to planters or flower boxes. Flower boxes are used to hold soil and allow flowers to grow therein. Typically, flower boxes are constructed of wood, plastic or metal and are rectilinear or square in shape. Since these flower boxes are generally placed in open locations that are visible to individuals, and they are generally unattractive, the need exists for facades to hide their appearance and present a more visually appealing sight.

It is therefore a principal object and advantage of the present invention to provide an ornamental device that may be removably attached to a flower box.

It is another object and advantage of the present invention to provide an ornamental device for a flower box that is modular and adaptable to interconnection with differently sized flower boxes.

It is a further object and advantage of the present invention to provide an ornamental device that is easily and inexpensively manufactured.

Other objects and advantages of the present invention will in part be obvious, and in part appear hereinafter.

### SUMMARY OF THE INVENTION

In accordance with the foregoing objects and advantages, the present invention contemplates a decorative attachment to a flower box, comprising modular panels adapted for interconnection to one another. Each panel includes interconnect members having opposing ends, one of which includes a male member extending therefrom and the other of which includes a female socket. The male members and sockets permit the panels to be interconnected to one another, and hence modular and adaptable to fit various sized flower boxes. Some of the panels further include a hook attached to their rear surfaces which interconnect the panels to a flower box, and a spacer member attached to a panel's rear surface. The spacer maintains the panels in a vertically extending plane when connected to a flower box. The invention is shown with each panel shaped in the form of a picket, but the invention would work just as well with the panels taking the form of other decorative items.

### BRIEF DESCRIPTION OF THE DRAWING FIGS.

The present invention will be better understood and more fully appreciated by reading the following Detailed Description in conjunction with the accompanying drawing figures, wherein:

FIG. 1 is a front elevational view of the present invention;

FIG. 2 is a top plan view thereof;

FIG. 3 is a side elevational view thereof;

FIG. 4 is a side elevational, cross-sectional view of the present invention interconnected to a flower box;

FIG. 5 is a front elevational view of a modular panel that comprises part of the present invention;

FIG. 6 is a side elevational view of a spacer member element of the present invention;

FIG. 7 is an enlarged, top plan view of a portion of the present invention encircled in FIG. 2; and

FIG. 8 is an exploded, top plan view of the elements illustrated in FIG. 7.

### DETAILED DESCRIPTION

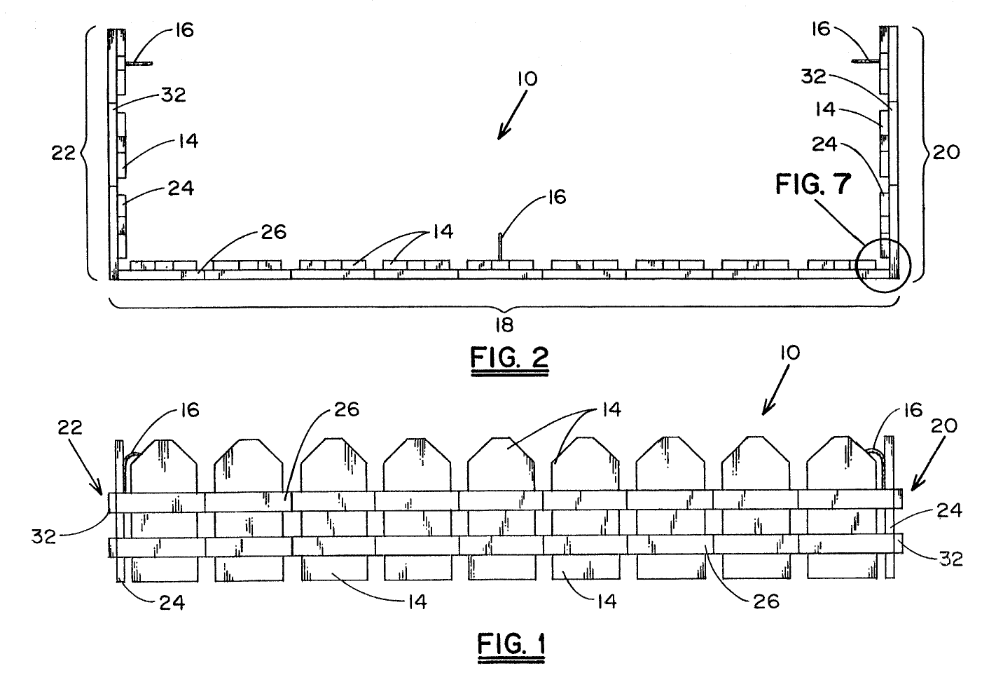

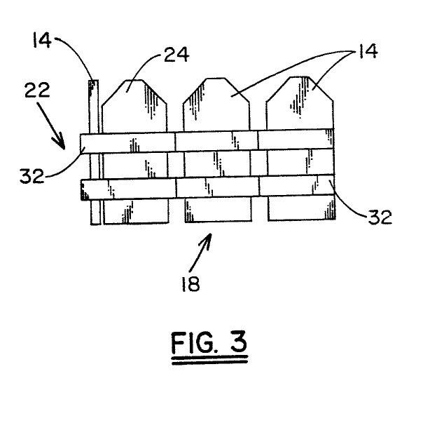

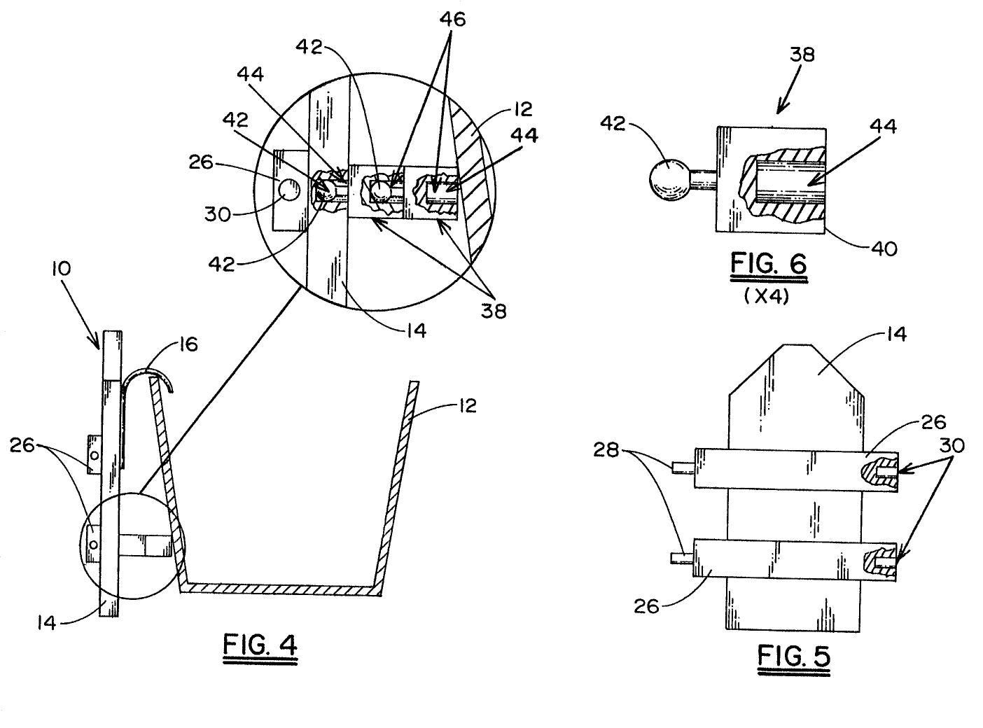

Referring now to the drawings, wherein like reference numeral refer to like parts throughout, there is seen in FIG. 1 a decorative flower box attachment device, designated generally by reference numeral 10, that may be removably connected to a flower box 12 (see FIG. 4). Attachment device 10 generally comprises a series of interconnected panels 14, some of which include a hook 16 attached to their rear surfaces, adjacent their upper ends and which are adapted to engage the upper lip of flower box 12, as illustrated in FIG. 4. To surround two or more sides of flower box 12, a first section 18 of panels 14 can be arranged to extend in a first plane, a second section 20 in a second plane, a third section 22 in a third plane, and so forth (see FIG. 2). The various sections 18, 20, and 22 can be interconnected through use of comer panels 24 which permit joinder of panel sections 18 and 20 or sections 18 and 22 at predetermined angles (the drawings only illustrate 90 degree attachments, but the present invention could use panels that interconnect at other angles as well), as will be explained in greater detail hereinafter.

With specific reference to FIG. 5, panels 14 include legs 26 attached thereto and extending transversely thereacross. One end of legs 26 include male members 28 extending longitudinally therefrom while the opposite ends include sockets 30 formed longitudinally therein. In constructing a section 18, 20, or 22, a user would insert the male member 28 of one panel 14 into the sockets 30 of a second panel 14. As many panels 14 as are necessary to accommodate the length of a particular flower box 12 would be interconnected in this manner.

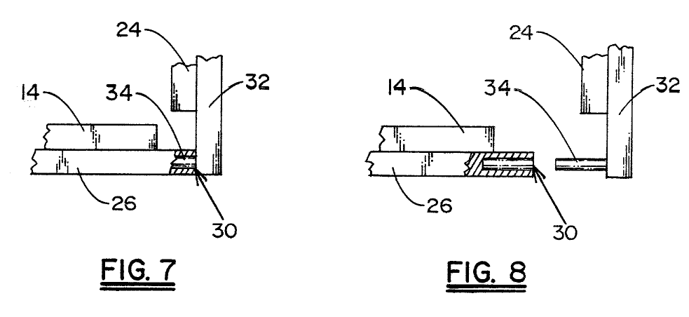

With specific reference to FIGS. 7-8, to transition from one section 18 to another section 20 or 22, comer panels 24 are used. Comer panels 24 each include legs 32 extending transversely thereacross with male members 34 extending rearwardly from one end of legs 36 and sockets formed longitudinally in the opposite ends of legs 32. In the drawings, male members 34 are illustrated as extending perpendicularly rearward from legs 32, thereby forming a 90 degree joinder of sections 18 to 20 or 18 to 22. However, it should be understood that male members 34 could extend rearward from legs 32 at any predetermined angle, thereby accommodating a flower box 12 having any peripheral outline (e.g., 60 degree corners for a triangularly or hexagon shaped flower box, 45 degree comers for an octagon shaped flower box, etc. . . ). Once members 34 from a comer panel 24 are inserted into the sockets 30 of a panel 14 from an adjoining section, an additional panel 14 in the same section 20 or 22 can be interconnected to panels 24.

Once all the desired sections 18, 20, 22 are formed, they may be connected to flower box 12 by hanging hooks 16 over the flower box's lip. Depending on the shape of flower box 12, however, sections 18, 20, 22 may not hang in an entirely vertical plane. To ensure that sections 18, 20, 22 hang in an entirely vertical plane, spacers 38 may be attached to the rear surfaces of some or all of panels 14, 24. Referring to FIGS. 4 and 6, spacers 38 comprise body portions 40 and interconnect knobs 42. The rear surfaces of panels 14, 24 include an opening 44 to removably receive a knob 42 therein, and the rear surfaces of body portions 40 also include openings 46 formed therein to removably receive knobs 40 therein. By snap engaging as many spacers 38 to one another as are necessary, sections 18, 20, 22 may be vertically aligned when hanging on flower box 12.

Although panels 14, 24 are illustrated as pickets, it should be understood that they may take any form/shape, such as animal, flower, or other item

What is claimed is:

1. A decorative attachment for a flower box, comprising:
a. a plurality of elongated panels each having a first rear surface;
b. an interconnection member attached to each of said plurality of panels for interconnecting two of said plurality of panels to one another; and
c. a spacer member removably connected to said rear surface for aligning said plurality of panels in a vertical plane when they are attached to said flower box.

2. The decorative attachment for a flower box of claim 1, wherein said interconnection member comprises an elongated leg attached to one of said plurality of panels and having a first end with a male member extending longitudinally therefrom and an opposing second end with a socket formed therein.

3. The decorative attachment for a flower box of claim 1, wherein said interconnection member comprises an elongated leg attached to one of said plurality of panels and having a second rear surface, a first end, an opposing second end with a socket formed therein, and a male member extending outwardly at a predetermined angle from said second rear surface, adjacent said first end.

4. The decorative attachment for a flower box of claim 1, wherein said predetermined angle is 90 degrees.

5. The decorative attachment for a flower box of claim 1, wherein said spacer member comprises a body portion having opposed first and second surfaces, a knob extending from said first surface, and an opening formed in said second surface.

6. The decorative attachment for a flower box of claim 5, wherein said first rear surface includes a knob receiving opening formed therein.

7. The decorative attachment for a flower box of claim 1, further comprising a hook attached to said first rear surface of at least one of said plurality of panels.

8. The decorative attachment for a flower box of claim 1, wherein each of said plurality of panels is shaped in the form of a picket.

9. A decorative attachment for a flower box, comprising:
a. a plurality of elongated panels each having a first rear surface;
b. means for interconnecting two of said plurality of panels to one another; and
c. means for aligning said plurality of panels in a vertical plane when they are attached to said flower box.

10. The decorative attachment for a flower box of claim 9, wherein said interconnecting means comprises an elongated leg attached to one of said plurality of panels and having a first end with a male member extending longitudinally therefrom and an opposing second end with a socket formed therein.

11. The decorative attachment for a flower box of claim 9, wherein said interconnecting means comprises an elongated leg attached to one of said plurality of panels and having a second rear surface, a first end, an opposing second end with a socket formed therein, and a male member extending outwardly at a predetermined angle from said second rear surface, adjacent said first end.

12. The decorative attachment for a flower box of claim 11, wherein said predetermined angle is 90 degrees.

13. The decorative attachment for a flower box of claim 9, wherein said alignment means comprises a spacer member comprising a body portion having opposed first and second surfaces, a knob extending from said first surface, and an opening formed in said second surface.

14. A modular, decorative attachment for a flower box, comprising:
a. a plurality of elongated panels each having a first rear surface;
b. a hook attached to said first rear surface of at least one of said plurality of panels; and
c. an interconnect member attached to and extending transversely across each of said plurality of panels, and comprising first and second opposing ends and a second rear surface.

15. The modular, decorative attachment for a flower box of claim 14, wherein said first end includes a male member extending longitudinally therefrom, and said second end includes a socket formed longitudinally therein.

16. The modular, decorative attachment for a flower box of claim 14, wherein said interconnect member includes a male member extending outward at a predetermined angle from said second rear surface, adjacent said first end, and said second end includes a socket formed longitudinally therein.

17. A modular system for enclosing a plurality of sides of a flower box, comprising:
a. a first plurality of interconnected panels extending in a first plane, each of said first plurality of panels including a first rear surface;
b. a second plurality of interconnected panels extending in a second plane that angularly intersects said first plane, said second plurality of panels being interconnected to said first plurality of panels and each including a second rear surface;
c. a third plurality of interconnected panels extending in a third plane that angularly intersects said first plane, said third plurality of panels being interconnected to said first plurality of panels and each including a third rear surface; and
d. a hook attached to said first, second, and third rear surfaces of at least one of said first, second, and third plurality of panels, respectively.

18. The modular system for enclosing a plurality of sides of a flower box, further comprising a spacer member removably connected to said first, second, and third rear surfaces of at least one of said first, second, and third plurality of panels, respectively, for vertically aligning said first, second, and third planes when said first, second, and third plurality of panels are attached to said flower box.

19. A modular system for enclosing a plurality of sides of a flower box, comprising:
a. a first plurality of interconnected panels extending in a first plane, each of said first plurality of panels including a first rear surface;
b. a second plurality of interconnected panels extending in a second plane that angularly intersects said first plane, said second plurality of panels being interconnected to said first plurality of panels and each including a second rear surface;
c. a third plurality of interconnected panels extending in a third plane that angularly intersects said first plane, said third plurality of panels being interconnected to said first plurality of panels and each including a third rear surface; and
d. a spacer member removably connected to said first, second, and third rear surfaces of at least one of said first, second, and third plurality of panels, respectively, for vertically aligning said first, second, and third planes when said first, second, and third plurality of panels are attached to said flower box.

20. The modular system for enclosing a plurality of sides of a flower box of claim 19, wherein each of said plurality of panels is shaped in the form of a picket.
